(19) United States
(12) Patent Application Publication
(10) Pub. No.: US 2010/0176723 A1
(43) Pub. Date: Jul. 15, 2010

(54) HIGH PRESSURE MERCURY LAMP

(75) Inventors: Akihisa MORIMOTO, Himeji-shi (JP); Kyosuke FUJINA, Himeji-shi (JP); Takehiko IGUCHI, Himeji-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: USHIO DENKI KABUSHIKI KAISHA, Tokyo (JP)

(21) Appl. No.: 12/685,704

(22) Filed: Jan. 12, 2010

(30) Foreign Application Priority Data
Jan. 14, 2009 (JP) 2009-005627

(51) Int. Cl. H01J 61/04; H01J 61/20

(52) U.S. Cl. 313/633; 313/639; 313/642

(57) ABSTRACT

To devise a UV light source which has an increased UV irradiance in the short wavelength range, prevents blackening of the light emission tube and a decrease of the irradiance and has a long durability, a high pressure mercury lamp of the direct current type is provided, comprising a light emission tube, a cathode and an anode arranged at a distance oppositely to each other inside said light emission tube, said cathode having a shape of a truncated cone with a flat part at a tip end thereof, mercury filled inside said light emission tube in an amount of 0.05 to 0.10 mg/mm³, wherein the distance between the cathode and the anode is 1.4 to 1.8 mm, and a tip diameter of the flat part at the tip end of the cathode is 0.1 to 0.3 mm.

### BACKGROUND OF THE INVENTION

1. Field of the Invention

The present invention relates to high pressure mercury lamps, and in particular to high pressure mercury lamps filled with mercury which are used as mercury lamps employed in UV (ultraviolet) irradiation type semiconductor inspection devices, which are utilized in the process of inspecting the appearance of semiconductor wafers, or as UV light sources for the ink hardening of inkjet printers.

2. Description of Related Art

Hitherto, small high pressure mercury lamps with a mercury filling amount of 0.15 mg/mm³ have been used as light sources for projectors emitting mainly visible light.

In recent years, such high pressure mercury lamps have also been used as UV light sources employed in UV irradiation type semiconductor inspection devices or as UV light sources for the ink hardening of inkjet printers. FIG. 7 shows the schematic configuration of a known high pressure mercury lamp.

In FIG. 7, a light emission tube 10 of a high pressure mercury lamp 1 is provided with a spherical light emission part 11 made from quartz glass and positioned in the middle, and cylindrical sealing parts 12 at both ends. In a light emission space S, a cathode 13 and an anode 14 made from, for example, tungsten are arranged oppositely to each other, and 0.15 mg/mm³ or more of mercury and a rare gas and a certain amount of halogen are enclosed as light emission material. The cathode 13 and the anode 14 are sealed air-tight with the base end part being embedded in the sealing part 12, are connected to a metal foil 15 also being embedded in the sealing part 12 and to an outer lead 16, one end of which projects from the sealing part 12, and are supplied with direct current from a power source not shown.

While the above mentioned high pressure mercury lamp is a small UV light source and 0.15 mg/mm³ or more of mercury are enclosed as light emission material, the cathode 13 and the anode 14 are made from high-purity tungsten having a purity of at least 4 N (99.99 wt. %), and therefore the rate of irradiance of the amount of UV light can be maintained for a long time and a long durability is achieved (JP-A-2005-197191 and corresponding US 2005/0151471 A1).

With UV irradiation type semiconductor inspection devices or inkjet printers, in which such high pressure mercury lamps are used, a further improvement of the irradiance in the short wavelength range of the UV light source and a further extension of the durability are desired.

The present inventors have altered the mercury filling amount of the lamp such that it lies in the range of 0.05 to 0.10 mg/mm³ and tried to improve the light emission intensity in the short wavelength range. FIG. 3 shows the light emission spectrum measured for this mercury lamp for a UV light source while altering the mercury filling amount. Among the short wavelength light emitted from the mercury lamp for a UV light source, for example light with a wavelength of 254 nm is used for ink hardening while light with a wavelength of 365 nm is used for the semiconductor inspection. In FIG. 3, the horizontal axis shows the wavelength (nm) and the vertical axis shows the irradiance (W/cm²). It can be seen that in comparison to a lamp having a mercury filling amount of 0.16 mg/mm³, the emission peak values for the wavelengths of 254 nm and 365 nm are highly increased with lamps having 0.05 mg/mm³ and 0.10 mg/mm³. Thus, it was possible to improve the light emission intensity of the short wavelength range of mercury lamps for a UV light source.

But by means of reducing the mercury filling amount, also the lamp voltage decreased to less than before. Therefore, when performing a constant power control, the lamp current increased, the temperature of the electrodes increased and the electrode material evaporated because of which the wear of the electrodes increased. With high pressure mercury lamps, the lamp voltage changes according to the mercury filling amount, when the same power is supplied to the lamp. Thus, the lamp voltage decreases and the lamp current increases when the mercury filling amount is reduced. Therefore, because of the low thermal capacity and the temperature tending to increase, the electrodes and in particular the cathode, the tip of which is tapering in a sharp and roughly conical shape, are heated excessively and are evaporated and easily worn out.

The wear of the electrodes is the cause for various problems. When the evaporated electrode material adheres to the inner surface of the light emission tube, blackening of the light emission tube occurs, by which also the appearance becomes black, and the light transmittance decreases. When the spacing between the electrodes increases because of the wear of the electrodes, the light cannot be focused effectively because of the expansion of the arc, and the irradiance decreases. That means, the initial irradiance of the short wavelength range of the UV rays was increased, but there was the problem that the durability of the lamp (the irradiance maintenance rate) decreased accordingly and the utility as a light source for a semiconductor inspection device or for the ink hardening was not satisfactory.

### SUMMARY OF THE INVENTION

The present invention was made to solve the abovementioned problems. Thus, a primary object of the present invention is to provide a high pressure mercury lamp for a UV light source which has an increased UV irradiance in the short wavelength range, prevents blackening of the light emission tube and a decrease of the irradiance and has a long durability.

In a first aspect, the present invention relates to a direct current type high pressure mercury lamp, wherein a cathode and an anode are arranged oppositely to each other in the interior of a light emission tube and mercury is filled into the interior of this light emission tube with an amount of 0.05 to 0.10 mg/mm³, the cathode has the shape of a truncated cone with a flat part at the tip end, and the electrode distance between the cathode and the anode is 1.4 to 1.8 mm and the tip diameter of the cathode is 0.10 to 0.30 mm.

In a further development of the first aspect, a halogen is filled inside the light emitting tube in an amount of 1×10⁻⁷ to 1×10⁻² μmol. The halogen preferably is bromine

In a still further embodiment, a rare gas is filled inside the light emitting tube. The rare gas preferably is argon.

In another embodiment, oxygen is filled inside the light emitting tube in an amount of 0.05 to 0.45 vol. % with regard to the filling pressure of said rare gas.

In a further embodiment of the high pressure mercury lamp of the invention, the electrodes consist of tungsten having a purity of at least 99.99 wt. %.

According to the invention, the irradiance in the short wavelength range of the UV rays is large because of the filling amount of mercury being 0.05 to 0.10 mg/mm², and the amount of the wear of the electrodes is reduced, the irradiance maintenance rate is high and the durability is long because of the electrode distance AL being 1.4 to 1.8 mm and the tip diameter D being 0.1 to 0.3 mm.

### BRIEF DESCRIPTION OF DRAWINGS

FIG. 1 is a general view schematically showing the configuration of a high pressure mercury lamp according to one embodiment of the present invention.

FIG. 2 is an enlarged sectional view schematically showing the configuration of the interior of the light emission tube of the high pressure mercury lamp of the present invention.

FIG. 3 is a diagram showing light emission spectra for distinct mercury filling amounts in mercury lamps.

FIG. 4 is a diagram showing test results for the high pressure mercury lamp of the present invention.

FIG. 5 is a diagram showing test results for the high pressure mercury lamp of the present invention.

FIG. 6 is a diagram showing test results for the high pressure mercury lamp of the present invention.

FIG. 7 is a general view showing the configuration of a conventional high pressure mercury lamp.

### DETAILED DESCRIPTION OF THE INVENTION

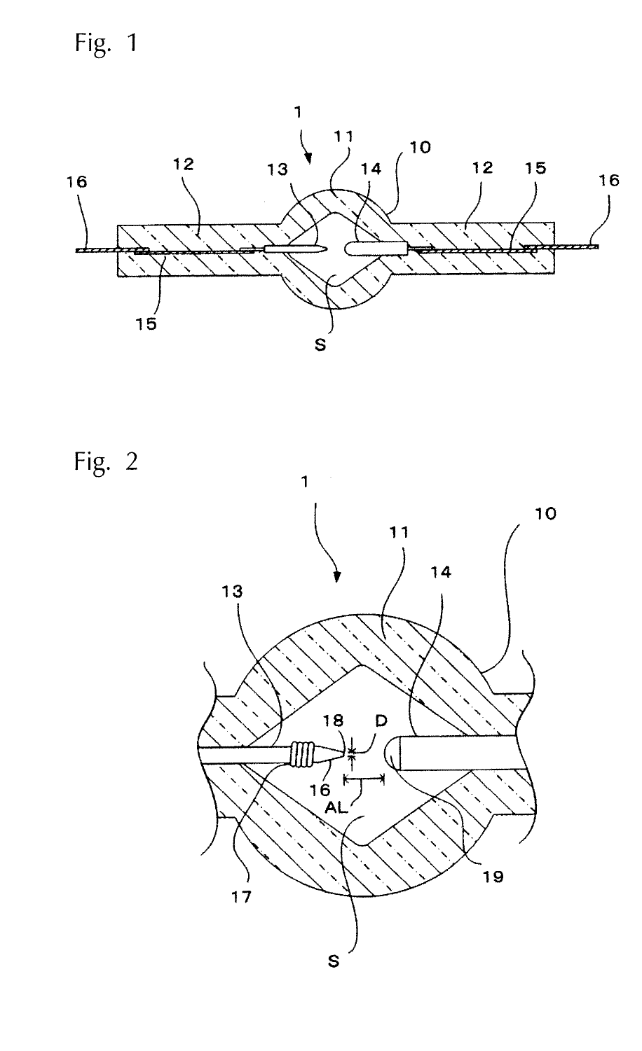

FIG. 1 is a general view schematically showing the configuration of a high pressure mercury lamp according to one embodiment of the present invention.

In FIG. 1, a light emission tube 10 of a high pressure mercury lamp 1 has a light emission part 11 made from quartz glass and being spherical in the middle and having cylindrical sealing parts 12 connected to both ends of this light emission part 11. The longitudinal length of the light emission tube 10 is 45 to 55 mm and for example 50 mm. In the interior of the light emission tube 10, a cathode 13 and an anode 14 forming an electrode pair are arranged oppositely to each other. Tungsten is used as the material of the electrodes. To suppress blackening, pure tungsten having a purity of 4 N (99.99 wt. %) or more is preferred. Each electrode is connected by welding to a metal foil 15 embedded in the sealing part 12, while an outer lead 16 projecting from the sealing part 12 to the outside is connected to the metal foil 15 and connected to a power source not shown. Such a sealing part 12 is formed, for example, by shrink sealing, and the electrical conduction of the electrodes in the light emission tube and the outer leads projecting to the outside is effected by means of the metal foil.

0.05 mg/mm³ to 0.10 mg/mm³ mercury are filled into the interior of the light emission tube 10 as light emission gas. Thereby, the light emission intensity with a short wavelength of at most 400 nm rises, and in particular the irradiance with 365 nm and 254 nm is highly increased. Further, bromine being a halogen to obtain the so-called halogen cycle effect is contained in an amount of 1×10⁻⁷ to 1×10⁻² μmol, and argon is contained as a rare gas to facilitate the starting. The inclusion of 0.05 to 0.45% (vol. %) oxygen with regard to the filling pressure of this rare gas has the effect to increase the vapor pressure of tungsten compounds adhering to the light emission tube inner wall part and generated by the wear of the electrodes, and blackening can be suppressed.

When a direct current voltage is applied from a power source not shown connected to the outer leads 16 at both ends of such a high pressure mercury lamp, a discharge occurs in the light emission space S and an arc is formed. The power feed to this lamp is performed, for example, by means of a constant power control method. The input power amounts preferably to 150 to 250 W, for example 200 W.

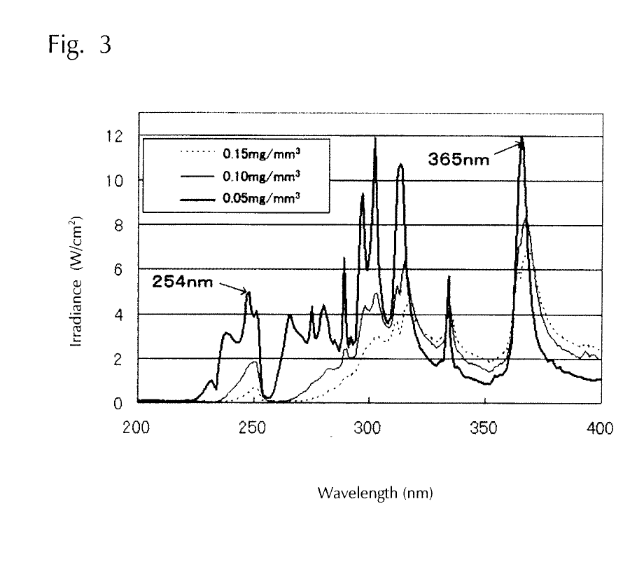

FIG. 2 is an enlarged sectional view of the main part schematically showing the configuration of the interior of the light emission tube of the high pressure mercury lamp according to the present invention. In FIG. 2, the cathode 13 has a roughly cylindrical shape with the base end side being embedded in a sealing part 12 and the tip side projecting into the light emission space S. The tip side forms a conical part 16 with the shape of a truncated cone and has a flat part 18 perpendicular to the longitudinal direction at the tip end. At the side of the cathode 13 being closer to the base end than the conical part 16 a coil 17 is wound to facilitate the starting of the lighting. The anode 14 opposing this cathode 13 has a cylindrical shape, and similar to the cathode 13 the base end part is embedded in a sealing part 12. In pursuit of stability of the arc spot of the tip end of the anode 14, for example a spherical surface part 19 can be provided.

The cathode 13 and the anode 14 are arranged spaced by an electrode distance AL (mm). The length of the electrode distance AL is established from the spacing between the tip end of the cathode 14 and the tip end of the anode. When the electrode distance AL is too short, the current value increases because of a decrease of the lamp voltage, the wear of the cathode becomes extensive, and the durability of the lamp decreases. When the electrode spacing AL is too long, the focusing efficiency is poor because the arc expands, and the initial irradiance decreases.

The flat part 18 present at the tip end of the cathode 13 is a roughly circular flat surface perpendicular to the longitudinal direction of the light emission tube 10, and the outer diameter of this flat part is set to a tip end diameter D (mm). By means of forming a flat part 18 at the tip end of the cathode 13, there is no part forming an apex as with cathodes having a sharp tip end, and therefore the area, in which the current flows, is increased and the current density can be decreased.

To increase the irradiance of the lamp, it is necessary to render the tip end of the cathode 13 in a taper-shape and to shrink the arc, but when the tip end diameter D of the flat part 18 at the tip end is too small, the tip end becomes almost needle-shaped, the discharge is concentrated and the current density becomes too high, and therefore the wear of the cathode becomes extensive and the durability of the lamp decreases. When the tip end diameter D is too large, the arc expands and the irradiance decreases.

### EMBODIMENT 1

In the following, an embodiment of the invention of the present application is explained. High pressure mercury lamps according to the present invention were prepared in correspondence to FIG. 1.

Regarding the light emission tubes, quartz glass was used as the material and the complete length was approximately 50 mm. Regarding the mercury filling amount, 0.05, 0.08 and 0.10 mg/mm³, respectively, were used.

Using these high pressure mercury lamps, the initial irradiance was measured, then a durability test was performed and the irradiance maintenance rate was examined. The test lamps used for the measurement had the following specifications.

Regarding the lamps with a mercury filling amount of 0.10 mg/mm³, seven kinds of lamps were prepared in which the electrode distance AL was altered in an amount of 0.1 mm each within a range from 1.3 to 1.9 mm.

Regarding the lamps with a mercury filling amount of 0.05 and 0.08 mg/mm³, three kinds of lamps each were prepared in which the electrode distance AL was altered in an amount of 0.2 mm each within a range from 1.4 to 1.8 mm.

Regarding the tip end diameter D, five kinds of lamps within a range of 0.05 to 0.40 mm were prepared for the lamps with each of the above stated electrode distances.

The measurement of the initial irradiance was performed as follows.

For the measurement of the initial irradiance, lamps with an on-time of zero hours were used. For the lighting power source, a power source performing a constant power control as a direct current lighting method was used and the input power was set to 200 W.

The lamp was set in a lamp holder and arranged horizontally such that the height of the lamp became the same as that of the light reception part of a spectrophotometer. The lamp was switched on and then a waiting time of a few minutes followed until the irradiance stabilized. After the stabilization of the irradiance, the light emission spectrum was measured with the spectrophotometer. The total value for the irradiance (W/cm²) with a wavelength of 365 nm and the irradiance with a wavelength of 254 nm obtained in this way was adopted as the initial irradiance. This is because light with a wavelength of 365 nm is the light used for semiconductor inspection devices while light with a wavelength of 254 nm is the light used for ink hardening.

The calculation of the irradiance maintenance rate was performed as follows.

First, a durability test was performed, in which a lamp, for which the initial irradiance had been measured, was the test object. Regarding the lighting conditions, an on/off method repeating an on-time of 3.5 hours and an off-time of 30 minutes in accordance with the actual usage conditions of a lamp was employed until a total on-time (including the off-time) of 1000 hours was reached.

Then, the irradiance after the test was measured using the same method as above for the lamp having been subjected to the durability test of 1000 hours. The irradiance maintenance rate (%) was calculated by dividing the obtained irradiance after the test by the initial irradiance.

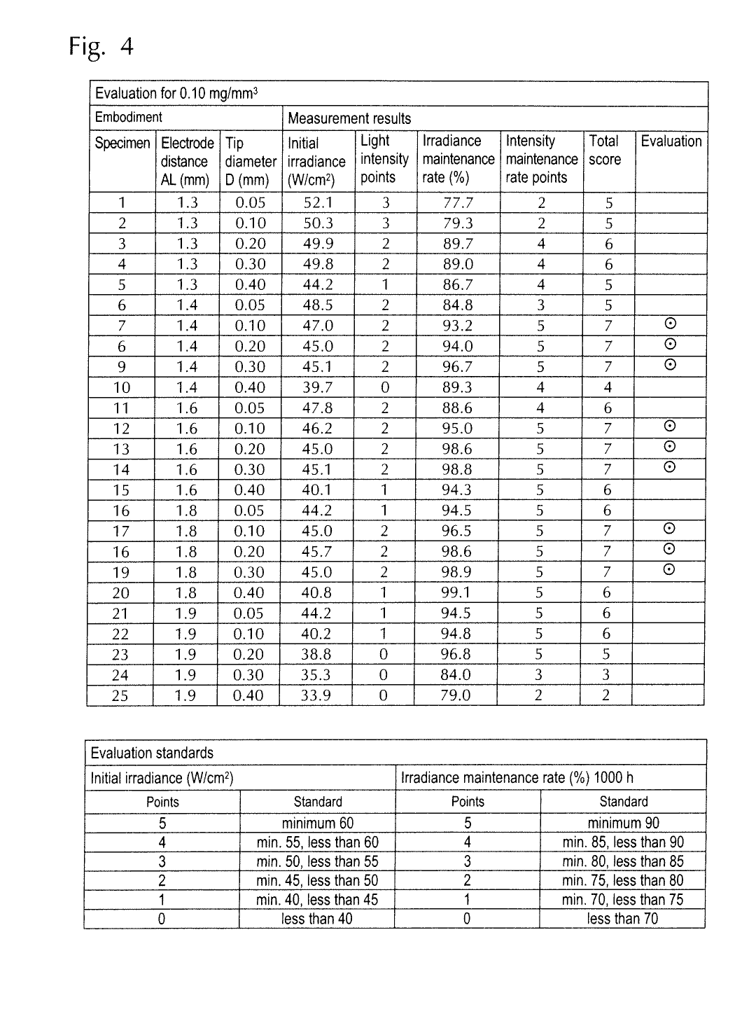

FIG. 4 is a table referring to the lamps with a mercury filling amount of 0.10 mg/mm³ summarizing the lamps, in which the spacing AL between the electrodes and the tip end diameter D had been altered with evaluations of the initial irradiance and the irradiance maintenance rate. For each evaluated lamp, evaluation points regarding the initial irradiance and the irradiance maintenance rate were assigned. The standards for the evaluation are shown in the table.

For an initial irradiance of less than 40 (W/cm²), 0 points were assigned, for at least 40 but less than 45 1 point was assigned, for at least 45 but less than 50 2 points were assigned, for at least 50 but less than 55 3 points were assigned, for at least 55 but less than 60 4 points were assigned, and for at least 60 5 points were assigned.

Regarding the irradiance maintenance rate, in the same way 0 points were assigned for less than 70 (%), 1 point was assigned for at least 70 but less than 75, 2 points were assigned for at least 75 but less than 80, 3 points were assigned for at least 80 but less than 85, 4 points were assigned for at least 85 but less than 90, and 5 points were assigned for at least 90.

The sum of the evaluation points for the initial irradiance and the evaluation points for the irradiance maintenance rate was the total score. A high total score for a test specimen means that it is a lamp being excellent with regard to both the initial irradiance and the irradiance maintenance rate, and having favorable characteristics for the practical use as a lamp for a UV light source.

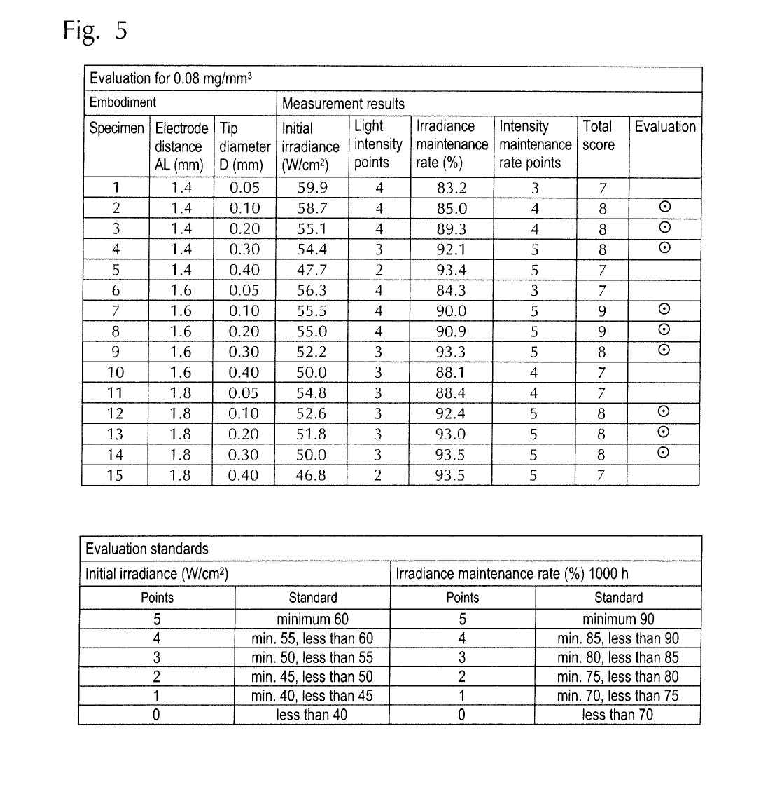

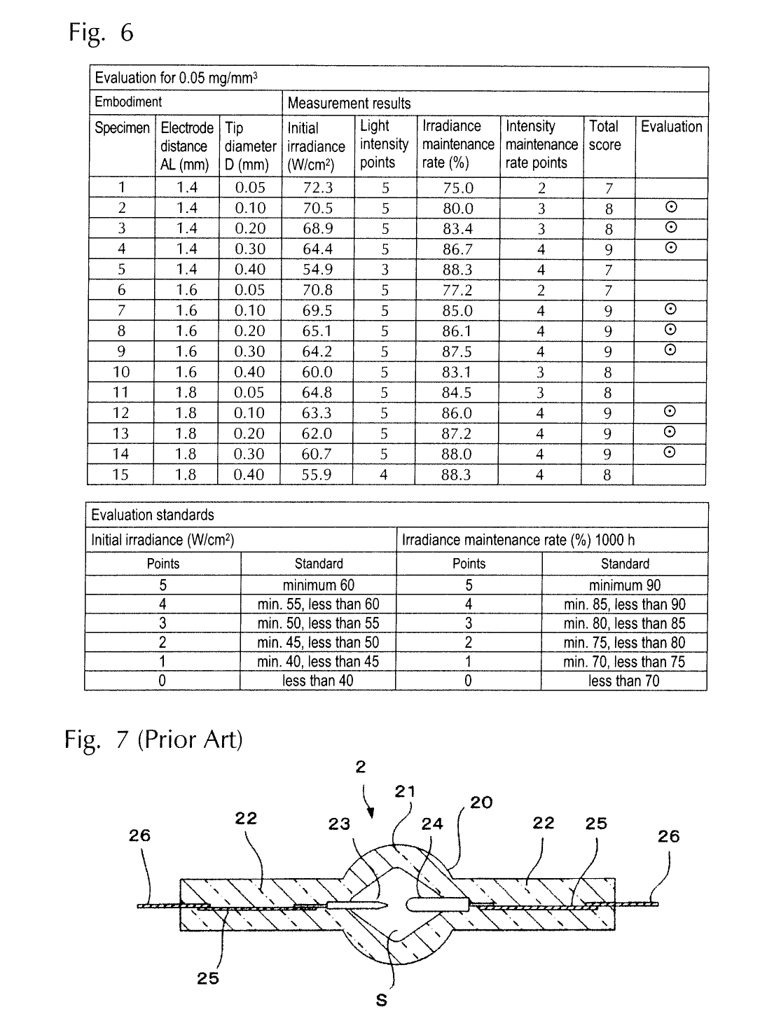

In FIG. 5 the test results for the lamps with a mercury filling amount of 0.08 mg/mm³ and in FIG. 6 those for the lamps with a mercury filling amount of 0.05 mg/mm² are shown.

Regarding the results shown in FIG. 4, when the electrode distance AL becomes small, there is the tendency that the initial irradiance is high but the irradiance maintenance rate is low with the electrode distance AL becoming smaller. When the electrode distance AL becomes large, there is the tendency that the initial irradiance is low but the irradiance maintenance rate is high. When test specimens with the same electrode distance AL are compared, for test lamps with a small tip end diameter D the initial irradiance tends to be high but the irradiance maintenance rate tends to be low. This is probably due to the fact, that, as mentioned above, the electrode distance AL has an influence on the lamp voltage and the arc length.

When the tip end diameter D of the cathode becomes small, there is the tendency that the initial irradiance is high but the irradiance maintenance rate is low. When the tip end diameter D of the cathode becomes large, there is the tendency that the initial irradiance is low but the irradiance maintenance rate is high. This is probably due to the fact that, as mentioned above, the tip end diameter D has an influence on the current density and the forming of the arc.

As stated above, both the electrode distance AL and the tip end diameter D have an influence on the initial irradiance and the irradiance maintenance rate, and both characteristics have a mutual tradeoff relationship. Within the scope of such a relationship, for a light source for a semiconductor inspection device or for the ink hardening it is preferred that the evaluations for both the initial irradiance and the irradiance maintenance rate are high.

With regard to the evaluation of both the initial irradiance and the irradiance maintenance rate being good, specimens with a high total score of both evaluations for each mercury filling amount were marked with ‘⊙’ in FIG. 4 to FIG. 6. As the initial irradiance of the mercury lamp differs according to the mercury filling amount, the evaluation of being good or not was performed as a relative evaluation among mercury lamps having the same mercury filling amount.

Regarding the specimens shown in FIG. 4, the specimens 7 to 9, 12 to 14 and 17 to 19 were assessed to be good. These specimens were contained in the range of an electrode distance AL of 1.4 to 1.8 mm and a tip end diameter D of 0.1 to 0.3 mm. Within this range, both the initial irradiance and the irradiance maintenance rate were assessed to be good.

Regarding the lamps with a different mercury filling amount, the specimens 2 to 5, 7 to 9 and 12 to 15 of the specimens shown in FIG. 5 were assessed to be good. These specimens had an electrode distance AL of 1.4 to 1.8 and a tip end diameter D of 0.1 to 0.3 mm.

Among the specimens shown in FIG. 6, the specimens 2 to 5, 7 to 9 and 12 to 15 were assessed to be good. These specimens had an electrode distance AL of 1.4 to 1.8 and a tip end diameter D of 0.1 to 0.3 mm.

Thus, for a mercury filling amount in the range of 0.05 to 0.10 mg/mm³, an electrode distance AL of 1.4 to 1.8 mm and a tip end diameter D of 0.1 mm to 0.3 mm are preferred with regard to both the initial irradiance and the irradiance maintenance rate.

As, according to the high pressure mercury lamp in accordance with the above stated configuration, the irradiance in the short wavelength range of the UV rays is high and in particular the light emission intensity of 365 nm and 254 nm is excellent because of a mercury filling amount of 0.05 to 0.10 mg/mm³, the lamp, while being of small dimensions, has wavelength characteristics suited for use as the light source for a semiconductor inspection device or as the light source for ink hardening.

By means of an electrode distance AL of 1.4 to 1.8 mm and a tip end diameter D of 0.1 to 0.3 mm, the electrode wear amount can be reduced and a long durability with a high irradiance maintenance rate can be achieved while a high irradiance can be maintained.

What is claimed is:

1. High pressure mercury lamp of the direct current type, comprising
a light emission tube,
a cathode and an anode arranged at a distance oppositely to each other inside said light emission tube,
said cathode having a shape of a truncated cone with a flat part at a tip end thereof,
mercury filled inside said light emission tube in an amount of 0.05 to 0.10 mg/mm³,
wherein the distance between the cathode and the anode is 1.4 to 1.8 mm, and
a tip diameter of the flat part at the tip end of the cathode is 0.1 to 0.3 mm.

2. High pressure mercury lamp of the direct current type according to claim 1, wherein a halogen is filled inside the light emitting tube in an amount of 1×10⁻⁷ to 1×10⁻² μmol.

3. High pressure mercury lamp of the direct current type according to claim 2, wherein the halogen is bromine.

4. High pressure mercury lamp of the direct current type according to claim 1, wherein a rare gas is filled inside the light emitting tube.

5. High pressure mercury lamp of the direct current type according to claim 4, wherein the rare gas is argon.

6. High pressure mercury lamp of the direct current type according to claim 4, wherein oxygen is filled inside the light emitting tube in an amount of 0.05 to 0.45 vol. % with regard to a filling pressure of said rare gas.

7. High pressure mercury lamp of the direct current type according to claim 1, wherein the electrodes consist of tungsten having a purity of at least 99.99 wt. %.
